(19) United States
(12) Patent Application Publication
(10) Pub. No.: US 2025/0157755 A1
(43) Pub. Date: May 15, 2025

(54) INPUT DEVICE AND PANEL

(71) Applicant: Panasonic Automotive Systems Co., Ltd., Kanagawa (JP)

(72) Inventors: Hideaki ETO, Osaka (JP); Takeshi MASUTANI, Kanagawa (JP)

(21) Appl. No.: 19/025,545

(22) Filed: Jan. 16, 2025

Related U.S. Application Data
(63) Continuation of application No. PCT/JP2023/038929, filed on Oct. 27, 2023.

(30) Foreign Application Priority Data
Nov. 28, 2022 (JP) 2022-189671
Jul. 31, 2023 (JP) 2023-124859

(51) Int. Cl. H01H 13/14; H01H 13/02

(52) U.S. Cl. CPC H01H 13/14; H01H 13/023; H01H 2215/00

(57) ABSTRACT

An input device includes: a panel that includes a surface on which a design for an operation is displayed; a holder that is provided on a back surface side of the panel and mechanically connected to the panel; a push-in detector that is provided on the back surface side of the panel and detects an operation on the panel from a user; and a vibration device that is mechanically connected to the holder and produces a vibration in a perpendicular direction perpendicular to the surface of the panel when the push-in detector detects that the panel has been operated. When viewed from the perpendicular direction, the panel includes a first portion on which the design is displayed and a second portion provided in a periphery of the first portion. The second portion is more flexible than the first portion.

### CROSS REFERENCE TO RELATED APPLICATIONS

This is a continuation application of PCT International Patent Application No. PCT/JP2023/038929 filed on Oct. 27, 2023, designating the United States of America, which is based on and claims priority of Japanese Patent Application No. 2022-189671 filed on Nov. 28, 2022 and Japanese Patent Application No. 2023-124859 filed on Jul. 31, 2023.

### FIELD

The present disclosure relates to input devices and panels.

### BACKGROUND

Conventionally, various input devices that accept input of operations by a user have been studied. For example, Patent Literature (PTL) 1 discloses an input device the entire input portion of which vibrates when a pressing operation is performed.

### CITATION LIST

### Patent Literature

PTL 1: Japanese Unexamined Patent Application Publication No. 2019-109673

### SUMMARY

The input device can be improved upon.

In view of this, the present disclosure provides an input device and a panel that are capable of improving upon the above related art.

An input device according to one aspect of the present disclosure comprising: a panel that includes a surface on which a design for an operation is displayed; a holder that is provided on a back surface side of the panel and mechanically connected to the panel; a first detector that is provided on the back surface side of the panel and detects an operation on the panel from a user; and a vibration device that is mechanically connected to the holder and produces a vibration in a perpendicular direction perpendicular to the surface of the panel when the first detector detects that the panel has been operated, wherein when viewed from the perpendicular direction, the panel includes a first portion on which the design is displayed, a second portion provided in a periphery of the first portion, and a third portion, when viewed from the perpendicular direction, the second portion includes a plurality of second divided portions, the plurality of second divided portions are annularly arranged spaced apart from each other to surround the first portion, the second portion is more flexible than the first portion, and the third portion is less flexible than the second portion.

An input device according to one aspect of the present disclosure is a panel that is provided on a surface of an input device, wherein the input device includes: a holder that is provided on a back surface side of the panel and mechanically connected to the panel; a first detector that is provided on the back surface side of the panel and detects an operation on the panel from a user; and a vibration device that is mechanically connected to the holder and produces a vibration in a perpendicular direction perpendicular to the surface of the panel when the first detector detects that the panel has been operated, when viewed from the perpendicular direction, the panel includes a first portion on which a design for an operation is displayed, a second portion provided in a periphery of the first portion, and a third portion, when viewed from the perpendicular direction, the second portion includes a plurality of second divided portions, the plurality of second divided portions are annularly arranged spaced apart from each other to surround the first portion, the third portion is provided in a gap in an annular arrangement direction of the plurality of second portions, the second portion is more flexible than the first portion, and the third portion is less flexible than the second portion.

According to one aspect of the present disclosure, it is possible to provide, for example, an input device capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view showing a configuration of an input device according to an embodiment.

FIG. 2 is a plan view showing the configuration of the input device according to the embodiment.

FIG. 3 is an exploded perspective view showing the configuration of the input device according to the embodiment.

FIG. 4 is a perspective view showing a panel according to the embodiment, which is viewed from a back side.

FIG. 5 is a cross-sectional view showing the input device according to the embodiment, which is taken along the cutting line V-V in FIG. 2.

FIG. 6 is a cross-sectional view showing the input device according to the embodiment, which is taken along the cutting line VI-VI in FIG. 2.

FIG. 7 is a block diagram showing a functional configuration of the input device according to the embodiment.

FIG. 8 is a plan view showing a configuration of an input device according to Variation 1 of the embodiment.

FIG. 9 is a cross-sectional view showing a panel according to Variation 2 of the embodiment, which is taken along a cutting line corresponding to the cutting line V-V in FIG. 2.

FIG. 10 is a cross-sectional view showing the panel according to Variation 2 of the embodiment, which is taken along a cutting line corresponding to the cutting line VI-VI in FIG. 2.

### DESCRIPTION OF EMBODIMENT

### (Circumstances Leading to the Present Disclosure)

An input apparatus having a seamless design in which a decorated panel and an input device are integrated has been considered. There has been a demand for improving the operability of such an input apparatus.

In view of this, the present disclosure provides, as further improvement, an input device and a panel whose operability is improved.

An input device according to one aspect of the present disclosure includes: a panel that includes a surface on which a design for an operation is displayed; a holder that is provided on a back surface side of the panel and mechanically connected to the panel; a first detector that is provided on the back surface side of the panel and detects an operation on the panel from a user; and a vibration device that is mechanically connected to the holder and produces a vibration in a perpendicular direction perpendicular to the surface of the panel when the first detector detects that the panel has been operated. When viewed from the perpendicular direction, the panel includes a first portion on which the design is displayed, a second portion provided in a periphery of the first portion, and a third portion. When viewed from the perpendicular direction, the second portion includes a plurality of second divided portions. The plurality of second divided portions are annularly arranged spaced apart from each other to surround the first portion. The second portion is more flexible than the first portion. The third portion is less flexible than the second portion.

With this configuration, since the second portion more flexible than the first portion is provided in the periphery of the first portion, the input device has a structure in which the first portion vibrates more easily. In other words, the vibration of the vibration device is easily transmitted to the first portion. Accordingly, since the vibration makes it easy for the user to recognize that the user has performed an operation, the operability of the input device is improved.

Moreover, for example, the second portion may be thinner than the first portion.

With this configuration, since it is only necessary to make the thicknesses of the first portion and the second portion different, it is possible to manufacture the input device easily.

Furthermore, for example, the second portion may include a material that is more flexible than a material of the first portion.

With this configuration, it is possible to improve the operability of the input device by simply making the materials of the first portion and the second portion different.

Moreover, for example, when viewed from the perpendicular direction, the second portion may include a plurality of divided portions.

With this configuration, it is possible to improve the elasticity of the periphery of the first portion while improving the operability of the input device, compared to a case in which the second portion is provided in the entire periphery of the first portion.

Furthermore, for example, the panel may be light-transmissive, and the input device may further include a light source that is provided on the back surface side of the panel and causes the panel to display the design.

With this configuration, it is possible to improve the operability of the input device configured to display a design using light from the light source.

Moreover, for example, a plurality of designs for operations may be displayed on the first portion, and the input device may further include a second detector that detects operation positions with respect to the plurality of designs.

With this configuration, it is possible to improve the operability of the input device configured to display the plurality of designs.

Furthermore, for example, the holder and the panel may be directly connected via at least two connectors, and when viewed from the perpendicular direction, the at least two connectors may be provided in positions that do not overlap the plurality of designs.

With this configuration, it is possible to prevent the at least two connectors from influencing the display of the plurality of designs. Accordingly, it is possible to achieve the input device the operability of which is improved while reducing a deterioration of design properties due to the at least two connectors.

Moreover, for example, the panel may include: a surface skin; a first resin layer that is provided on a back surface side of the surface skin; and a second resin layer that is provided on a back surface side of the first resin layer, the first resin layer may be more flexible than the second resin layer, and when viewed from the perpendicular direction, the surface skin, the first resin layer, and the second resin layer may be each provided over the first portion and the second portion.

With this configuration, since the input device includes the first resin layer that is flexible, the input device is capable of giving a soft tactile sensation to the user when the user operates the input device. Additionally, since the first resin layer is flexible, it is possible to effectively transmit the vibration using the second portion.

Furthermore, for example, a portion of the second resin layer that is located in the second portion may be thinner than a portion of the second resin layer that is located in the first portion.

With this configuration, it is possible to give flexibility to the second portion due to the thickness of the second resin layer.

Moreover, for example, a portion of the first resin layer that is located in the second portion may be as thick as a portion of the first resin layer that is located in the first portion.

With this configuration, since the first resin layer that is flexible is in uniform thickness, it is possible to give a soft tactile sensation to the user regardless of an operation position.

Furthermore, for example, the first resin layer may be thicker than the second resin layer.

With this configuration, since the thickness of the first resin layer that is flexible is great, it is possible to give a softer tactile sensation to the user when the user operates the input device.

A panel according to one aspect of the present disclosure is a panel that is provided on a surface of an input device. The input device includes: a holder that is provided on a back surface side of the panel and mechanically connected to the panel; a first detector that is provided on the back surface side of the panel and detects an operation on the panel from a user; and a vibration device that is mechanically connected to the holder and produces a vibration in a perpendicular direction perpendicular to the surface of the panel when the first detector detects that the panel has been operated. When viewed from the perpendicular direction, the panel includes a first portion on which a design for an operation is displayed, a second portion provided in a periphery of the first portion, and a third portion. When viewed from the perpendicular direction, the second portion includes a plurality of second divided portions. The plurality of second divided portions are annularly arranged spaced apart from each other to surround the first portion. The third portion is provided in a gap in an annular arrangement direction of the plurality of second portions. The second portion is more flexible than the first portion. The third portion is less flexible than the second portion.

With this configuration, by disposing such a panel in the input device, it is possible to produce the same advantageous effects as the above-described input device.

It should be noted that each of the embodiments described below represents a comprehensive or specific example of the present disclosure. A numerical value, a shape, a material, a structural component, and an arrangement position, connection form, and the like of the structural components described in the following embodiments are examples, and do not intend to restrict the present disclosure. Furthermore, among structural elements in the following embodiments, structural elements that are not described in independent claims will be described as optional structural elements. Each drawing is a schematic diagram and is not necessarily strictly illustrated. In each drawing, the same configurations are denoted by the same reference numerals.

In the present specification, terms indicating relationships between components such as equal, terms indicating the shape of components such as rectangular and circular, and numerical values are not expressions that express only strict meanings, but are expressions indicating substantially an equivalent range that contains a difference of several percentage points (or a level of 10%), for example.

Coordinate axes may be illustrated in the drawings to be used for description of the following embodiments and the like. The Z axis indicates a stacking direction in which each structural component of the input device is stacked. The X-axis direction and the Y-axis direction are directions that are orthogonal to each other on a plane perpendicular to the Z-axis direction. The perpendicular direction is a direction parallel to the Z-axis direction. In the following embodiments, a “plan view” means viewing in the Z-axis direction, and a “cross-sectional view” means viewing a cut surface cut along a plane parallel to the stacking direction (Z-axis direction).

In the description of the specification, ordinal numbers such as “first” and “second” do not mean the number or order of components, unless otherwise specified, and are used for the purpose of avoiding confusion between similar components and of distinguishing between them.

### Embodiment

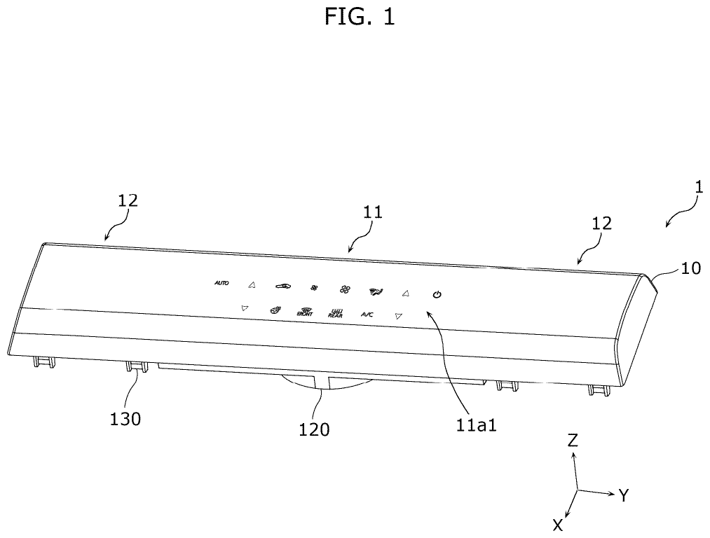

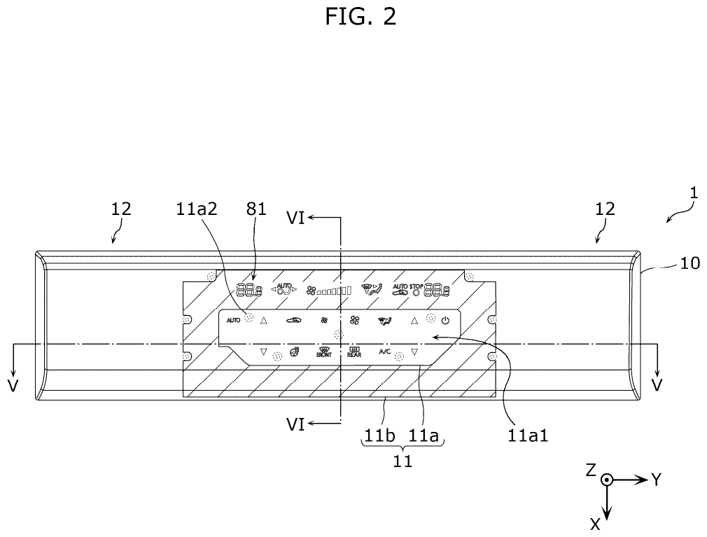

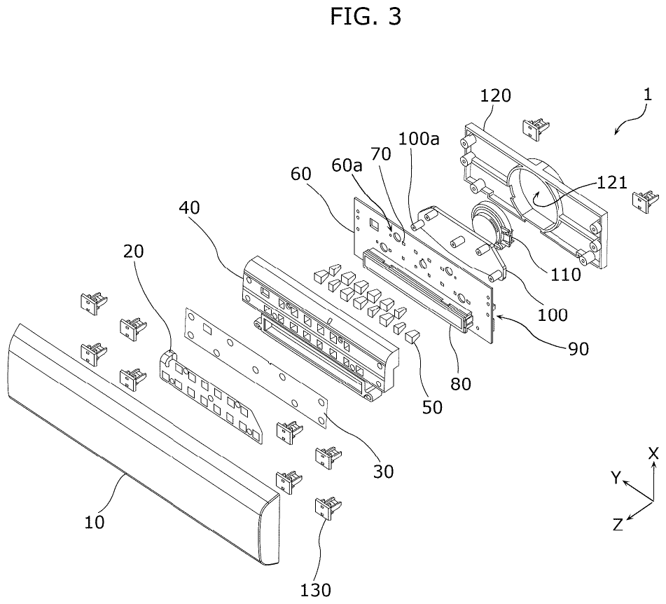

An input device according to the present embodiment will be described with reference to FIGS. 1 to 7. FIG. 1 is a perspective view showing a configuration of input device 1 according to the present embodiment. FIG. 2 is a plan view showing the configuration of input device 1 according to the present embodiment. FIG. 3 is an exploded perspective view showing the configuration of input device 1 according to the present embodiment. It should be noted that second portion 11b is hatched for identification, in FIG. 2.

As shown in FIG. 1, input device 1 receives input of an operation for controlling an apparatus included in a body (a vehicle such as a car, for example) on which input device 1 is mounted. Specifically, input device 1 accepts a push-in operation (hereinafter, also referred to simply as an operation) on a surface of panel 10 from a user. Input device 1 may be placed on an armrest, a console, an instrument panel, and the like.

When the body is a vehicle, the apparatus is an in-vehicle apparatus, such as a car navigation system, an audio apparatus for playing optical discs, a video reproducing apparatus, an air conditioning apparatus, and the like, but is not limited to them.

It should be noted that the body on which input device 1 is mounted is not limited to a vehicle. Input device 1 only needs to be mounted on a body that accepts operations from a user, and may be mounted on a home appliance, for example.

As shown in FIGS. 1 to 3, input device 1 includes panel 10, sensor film 20, diffusion sheet 30, light guide holder 40, light guide 50, substrate 60, light emitting element 70, display 80, push-in detector 90, holder 100, vibration device 110, cover 120, and clip 130. In input device 1, panel 10, sensor film 20, diffusion sheet 30, light guide holder 40 in which light guide 50 is accommodated, substrate 60, holder 100, vibration device 110, and cover 120 are stacked in this order.

Panel 10 is a user interface that has a surface (a surface in a plus side of the Z axis) on which predetermined design 11a1 is displayed, and is used for accepting operations from a user. A user can control apparatuses included in a vehicle by operating panel 10 (specifically, first portion 11a of operator 11). Panel 10 is, for example, a plate-shaped member in a plan view, and is pressed through the operation by a user.

In the present embodiment, panel 10 is formed of a material that has a light transmittance property. Panel 10 is formed of, for example, a transparent resin such as polycarbonate, or a light-transmissive elastomer, but is not limited to them.

Panel 10 has operator 11 and decorated part 12 in the plan view. Operator 11 and decorated part 12 are integrally formed. In other words, no gap is formed between operator 11 and decorated part 12 in the plan view. Operator 11 is a part that functions as an input device, and decorated part 12 is a part configured as a decorated panel. It should be noted that operator 11 and decorated part 12 may be decorated.

Operator 11 is a switch part that functions as a switch in input device 1. In other words, the switch part of input device 1 is a section where design 11a1 is displayed. A user operates a design part corresponding to an apparatus which the user intends to control, to thereby control the apparatus. In this embodiment, operator 11 has the light transmittance property.

Although details will be described later, operator 11 includes first portion 11a and second portion 11b, in the plan view. In first portion 11a, one or more designs 11a1 for operation are displayed. Second portion 11b is arranged around first portion 11a. In second portion 11b, designs 11a1 for the operation are not displayed. Second portion 11b is configured to have more flexibility than first portion 11a. Furthermore, second portion 11b may have more flexibility than decorated part 12, for example.

In the present embodiment, a plurality of designs 11a1 are displayed on first portion 11a. The number of designs 11a1 is not particularly limited as long as the number is one or more.

In the example shown in FIG. 2, second portion 11b is provided so as to seamlessly cover first portion 11a from its outside in the plan view, but second portion 11b is not limited thereto.

Decorated part 12 is a portion to which a desired decoration has been applied, and is a non-switch part that does not function as the switch in input device 1. Even if a user operates decorated part 12, no apparatus is controlled. Decorated part 12 is arranged in line with operator 11 in the plan view. In the example shown in FIG. 1, decorated part 12 is arranged to sandwich operator 11 from the left and right. It can also be said that decorated part 12 is an area that the user does not operate for the purpose of controlling apparatuses. Design 11a1 is not displayed on decorated part 12. Furthermore, decorated part 12 may have a light blocking property.

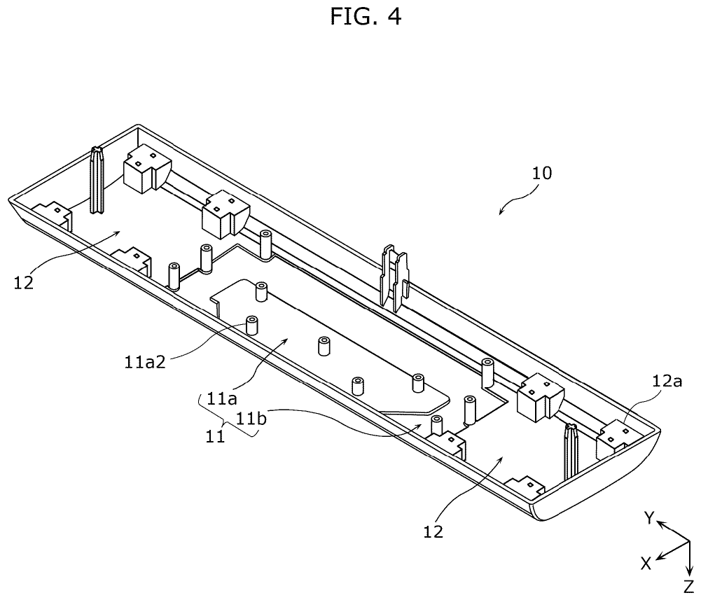

Here, a configuration of panel 10 will be further described with reference to FIG. 4. FIG. 4 is a perspective view showing panel 10 according to the present embodiment, which is viewed from a back side (a minus side of the Z axis).

As shown in FIG. 4, second portion 11b of operator 11 has a structure that is more flexible than first portion 11a, and has a thickness (length in the Z-axis direction) smaller than that of first portion 11a. In addition, second portion 11b is thinner than, for example, decorated part 12.

First portion 11a is provided with ribs 11a2 that protrude in the minus direction of the Z axis. Each rib 11a2 is connected to a corresponding one of ribs 100a that are provided on holder 100 and protrude in the plus direction of the Z axis, which will be described later. For example, a hole is provided in each rib 11a2, and a penetrating hole is provided in each rib 100a. Through the holes and the penetrating holes, panel 10 and holder 100 may be fixed to a fastening member (a screw, for example).

Each rib 11a2 is provided in a region that does not overlap with a plurality of designs 11a1 in the plan view. Ribs 11a2 are provided, for example, near the respective four corners of first portion 11a and in the vicinity of the center of first portion 11a in the plan view. With this configuration, the periphery and the center of first portion 11a of operator 11 can be vibrated in the same manner. Furthermore, ribs 11a2 are not provided in second portion 11b. Rib 11a2 is an example of a connector. Here, the vicinity of the center is, for example, a region that includes the center of gravity of first portion 11a in the plan view and is 20% or less of the area of first portion 11a, but is not limited thereto. Further, other ribs 11a2 may be arranged so as to surround rib 11a2 in the vicinity of the center in the plan view.

Attachment part 12a to which clip 130 is attached is arranged in decorated part 12.

In input device 1 including such panel 10, stimulation is applied to a tactile force sensation of a user while the user operates operator 11. Such stimulation is, for example, mainly embodied by operator 11. In other words, decorated part 12 may not generate such stimulation, for example. It should be noted that the stimulation is vibration in a direction perpendicular to the plane.

Referring again to FIGS. 2 and 3, sensor film 20 detects an operation position of a user with respect to a plurality of designs. Specifically, sensor film 20 is provided between panel 10 and diffusion sheet 30, and is a sensor for detecting the position where a user has operated (pressed) panel 10 (first portion 11a). Sensor film 20 is an example of a second detector.

In the present embodiment, sensor film 20 is an electrostatic capacity type sensor film (electrostatic sensor film) having the light transmittance property. Sensor film 20 is arranged in a region overlapping with at least first portion 11a in the plan view. Sensor film 20 is provided individually for each of a plurality of designs 11a1 in the plan view, and has an electrode (sensor electrode) for detecting the operation position (which design has been operated).

When only one design 11a1 is displayed on first portion 11a, sensor film 20 may not be provided.

Diffusion sheet 30 is arranged between sensor film 20 and light guide holder 40 and diffuses light that passes through light guide 50 toward panel 10. Diffusion sheet 30 is composed of a light-transmissive resin plate (a polycarbonate plate, for example), a polyethylene terephthalate (PET) film, and the like containing inorganic fine particles such as silica and glass beads, or light-diffusing particles such as resin particles.

It should be noted that diffusion sheet 30 only needs to be placed between panel 10 and light guide holder 40, and may be placed between panel 10 and sensor film 20, for example. Alternatively, diffusion sheet 30 may not be provided.

Light guide holder 40 is a plate-shaped member provided between diffusion sheet 30 (or sensor film 20) and substrate 60. Light guide holder 40 has rigidity. Light guide holder 40 is made of a resin material, but is not limited thereto.

Light guide holder 40 is arranged in a region overlapping with at least first portion 11a, and is arranged, for example, in a region overlapping with operator 11, in the plan view. Furthermore, light guide holder 40 is not mechanically connected to holder 100. It should be noted that mechanical connection means that holder 100 is configured (connected) to move when holder 100 moves in the Z-axis direction. Even if holder 100 moves in the Z-axis direction, light guide holder 40 does not move in the Z-axis direction due to the movement of holder 100.

Penetrating holes are provided in light guide holder 40 to transmit light from a light source (light emitting element 70, for example). The penetrating holes are provided, for example, in respectively correspondence with a plurality of light emitting elements 70 (for example, on a one-to-one basis) included in the light source. In addition, the penetrating holes are provided in correspondence with design 11a1 of operator 11, for example. Light is transmitted through the penetrating holes. Accordingly, it can be said that light guide holder 40 has the light transmittance property.

Each light guide 50 is accommodated in the corresponding one of the penetrating holes of light guide holder 40 and guides light from the light source toward panel 10. Light guides 50 are made of, for example, a resin material, but is not limited thereto. Furthermore, light guides 50 may have the light blocking property.

It should be noted that light guide 50 may not be provided. In other words, light from the light source may pass through the penetrating holes (spaces) in light guide holder 40.

Substrate 60 is a plate-shaped member on which a plurality of light emitting elements 70 are provided. In the present embodiment, display 80 is further arranged on a front surface (a surface in the plus side of the Z axis) of substrate 60. Substrate 60 is a rigid substrate, but may be a flexible substrate. Substrate 60 is, for example, a glass substrate or a resin substrate, but is not limited thereto.

Substrate 60 is arranged in a region overlapping with at least first portion 11a and is arranged in, for example, a region overlapping with operator 11, in the plan view. It should be noted that substrate 60 is not mechanically connected to holder 100. Substrate 60 is formed with penetrating holes 60a through which ribs 100a of holder 100 are respectively inserted. Even if holder 100 moves in the Z-axis direction, substrate 60 does not move in the Z-axis direction due to the movement of holder 100.

Light emitting element 70 is mounted on the surface (the surface in the plus side of the Z axis) of substrate 60 and emits light for displaying design 11a1. A plurality of light emitting elements 70 are provided in a region overlapping with operator 11 in the plan view. Specifically, light emitting element 70 is provided in a region overlapping with each of a plurality of designs 11a1. Light emitting element 70 is arranged, for example, at each position on substrate 60, which faces the corresponding one of the plurality of designs 11a1. Light emitting element 70 is, for example, a light emitting diode (LED), but is not limited thereto.

The plurality of light emitting elements 70 may emit light of mutually different colors (a color according to design 11a1, for example), or may emit light of a single color (white, for example).

Display 80 is arranged on the front surface of substrate 60 (the surface in the plus side of the Z axis), and displays a status of an apparatus, and the like (status display 81 shown in FIG. 2, for example). Display 80 is provided so as to be able to display status display 81 in a region overlapping with second portion 11b in the plan view. Display 80 is embodied by a liquid crystal display device, an organic electro luminescence (EL) display device, or the like. It should be noted that display 80 may not be provided.

Push-in detector 90 is provided in panel 10 and detects that a user has operated first portion 11a. Push-in detector 90 is provided on the back surface side of panel 10. Push-in detector 90 is provided on, for example, substrate 60, and is configured to detect an operation from the user when a load above a certain level is applied to operator 11. Push-in detector 90 may be of a contact type or a non-contact type. Moreover, push-in detector 90 is of an electrostatic capacitive type and may include an electrostatic capacity sensor, or is of a mechanical type and may include a mechanical switch such as a tact switch or a load sensor. Push-in detector 90 is an example of a first detector.

Holder 100 is arranged on the back surface side of panel 10 and is mechanically connected to each of panel 10 and vibration device 110. Holder 100 has a function of transmitting vibrations generated by vibration device 110 to panel 10.

Holder 100 has ribs 100a that protrude from a surface toward the plus side of the Z axis. Ribs 100a are respectively connected to ribs 11a2, and are configured to be able to directly transmit vibrations generated by vibration device 110 to operator 11 (specifically, first portion 11a). With this configuration, holder 100 and first portion 11a vibrate together in the direction perpendicular to the plane, for example. Rib 100a is an example of the connector.

Holder 100 is made of, for example, a resin material, but is not limited thereto. Moreover, holder 100 has rigidity. Furthermore, for example, in the plan view, holder 100 is in the same shape as first portion 11a. Holder 100 is also called an exciter bracket.

Vibration device 110 is an actuator that stimulates a user's sensation of tactile force while the user operates first portion 11a of operator 11. Vibration device 110 is mechanically connected to holder 100 and generates vibration in the direction perpendicular to the surface of panel 10 (in the Z-axis direction) when push-in detector 90 detects that panel 10 is pressed. Vibration device 110 may be able to control at least one of the frequency and vibration intensity of the vibration in the direction perpendicular to the plane, for example.

Vibration device 110 is configured to include a vibrator that generates vibration. The vibrator may be, for example, a piezoelectric element made of a piezoelectric material, or may be a structure that operates in an electromagnetic manner, such as a motor, a solenoid, or a voice coil. Furthermore, the vibrator may be a linear resonant actuator, an artificial muscle, a shape memory actuator, or the like.

Vibration device 110 is arranged between holder 100 and cover 120 at a position overlapping with operator 11 (specifically, first part 11a) in the plan view. Vibration device 110 is arranged, for example, in the vicinity of the center of operator 11 in the plan view.

Cover 120 has recess 121 that accommodates vibration device 110, and covers panel 10 from below (from the minus side of the Z axis).

Cover 120 and substrate 60 are fixed to decorated part 12 of panel 10 using, for example, a fastening member. Furthermore, holder 100 and vibration device 110 are arranged between cover 120 and substrate 60. For example, cover 120 and substrate 60 are fixed with an interval that allows holder 100 and vibration device 110 to vibrate in a direction perpendicular to the plane.

Clip 130 is a fixing member for fixing input device 1 to another member. In the present embodiment, clip 130 is arranged on the back surface side of each of panel 10 and cover 120.

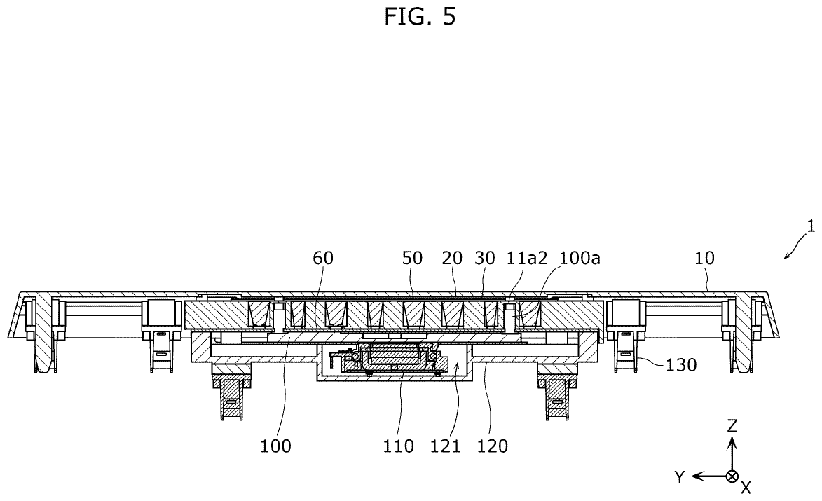

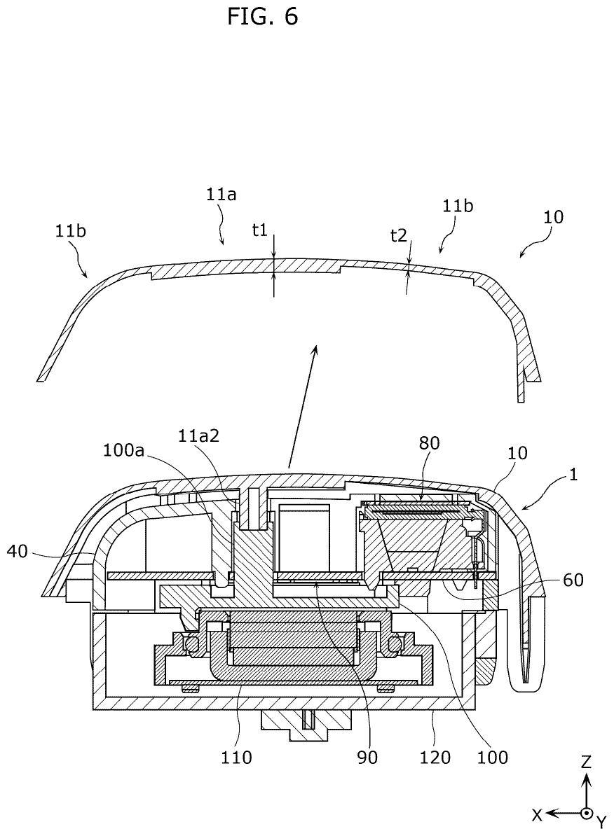

Here, the cross-sectional configuration of input device 1 configured as described above will be further described with reference to FIGS. 5 and 6. FIG. 5 is a cross-sectional view of input device 1 according to the present embodiment, which is taken along the cutting line V-V in FIG. 2. FIG. 6 is a cross-sectional view of input device 1 according to the present embodiment, which is taken along the cutting line VI-VI in FIG. 2. It should be noted that FIG. 6 shows, for convenience, a sectional view of input device 1 in a lower part of the sheet, and a sectional view of panel 10 in an upper part of the sheet. Furthermore, in FIG. 6, illustrations of sensor film 20, diffusion sheet 30, and the like are omitted.

As shown in FIGS. 5 and 6, holder 100 is directly connected to operator 11 (specifically, first portion 11a) of panel 10. Furthermore, as shown in FIG. 6, first portion 11a is thicker than second portion 11b. In other words, second portion 11b is thinner than first portion 11a. Assuming that the thickness (depth) of first portion 11a is t1 and the thickness (depth) of second portion 11b is t2, thickness t2 may be thinner than thickness t1, may be 70% or less of thickness t1, may be 50% or less of thickness t1, or may be 30% or less of thickness t1, for example. Thickness t1 and thickness t2 are appropriately determined depending on the performance, the intended use, and the like, required for the product. For example, thickness t1 is 2.7 mm, and thickness t2 is 1.3 mm, but they are not limited thereto.

It should be noted that thickness t1 described above is an average value of the thickness of first portion 11a, but may be a median value, mode, a maximum value, a minimum value, a representative value, and the like. Thickness t2 described above is an average value of the thickness of second portion 11b, but may be a median value, mode, a maximum value, a minimum value, a representative value, and the like.

First portion 11a and second portion 11b are, for example, integrally formed of the same material.

In such input device 1, when first portion 11a of operator 11 is pressed, second portion 11b that is provided around first portion 11a and has high flexibility is easily deformed (bent, for example). In other words, a user can operate operator 11 with a weaker pressing force, so that the operability at pressing is improved.

Furthermore, panel 10 has, for example, a partially curved shape. In the example of FIG. 6, both ends of panel 10 in the X-axis direction are curved. In such a case, a curved portion connected to first portion 11a (in the example of FIG. 6, the curved portion in the plus side of the X axis) may be formed thin. This makes it possible to effectively increase the flexibility of the portion that has become hard due to the curved shape.

In such input device 1, when pushing-in is detected by push-in detector 90, vibration device 110 vibrates in a direction perpendicular to the plane, and the vibration is directly transmitted to panel 10 (specifically, to operator 11) via holder 100. In other words, the vibration of vibration device 110 is not transmitted to light guide holder 40, substrate 60, and the like. Therefore, even if vibration device 110 vibrates, light guide holder 40, substrate 60, and the like do not vibrate. Holder 100 relatively vibrates (moves) in a direction perpendicular to the plane with respect to light guide holder 40, substrate 60, and the like.

Since vibration device 110 is connected to panel 10 via holder 100 and other components are not vibrated by vibration device 110, the vibration of vibration device 110 can be effectively transmitted to panel 10.

Furthermore, operator 11 has second portion 11b that is provided around first portion 11a and is more flexible than first portion 11a. Accordingly, operator 11 is easily deformed by force in a direction perpendicular to the plane, such as operation or vibration. In other words, input device 1 can effectively transmit vibrations to a user. Furthermore, decorated part 12 has lower flexibility than second portion 11b, to thereby prevent vibrations by vibration device 110 from being transmitted to decorated part 12 (vibration to first portion 11a becomes weaker).

Here, the configuration in which second portion 11b is more flexible than first portion 11a is not limited to second portion 11b being thinner than first portion 11a. For example, second portion 11b may be made of a material that has more flexible than that of first portion 11a. For example, second portion 11b may contain a more flexible material than first portion 11a contains. For example, first portion 11a may be formed of a first resin such as polycarbonate, and second portion 11b may be formed of an elastomer or a second resin (flexible resin) that is more flexible than the first resin. In such a case, panel 10 may be formed by two-color molding, for example. In this case, thickness t1 and thickness t2 may be equal.

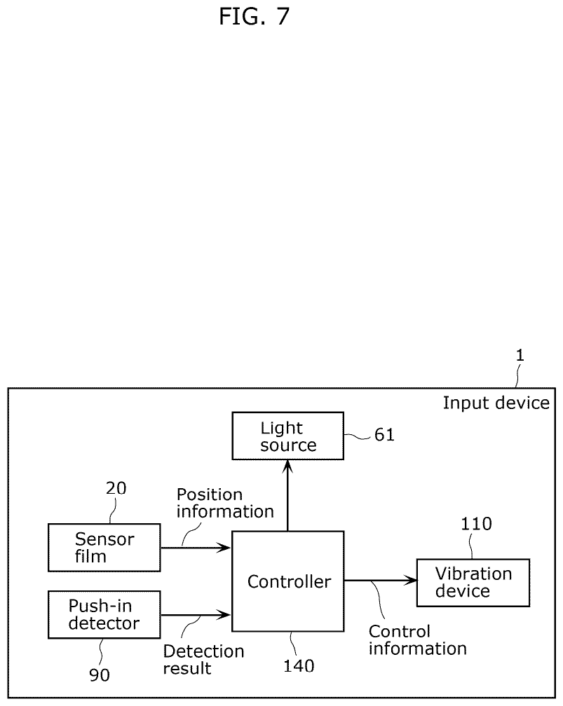

Next, a functional configuration of input device 1 will be described with reference to FIG. 7. FIG. 7 is a block diagram showing a functional configuration of input device 1 according to the present embodiment.

As shown in FIG. 7, input device 1 includes sensor film 20, light source 61, push-in detector 90, vibration device 110, and controller 140, as a functional configuration.

Light source 61 includes substrate 60 and light emitting element 70, is placed on the back surface side of panel 10, and is a light source for causing panel 10 to display a design for an operation, for example.

Controller 140 controls each component in input device 1. Controller 140 controls light source 61 to emit light, thereby causing design 11a1 to be displayed. Furthermore, controller 140 determines which design 11a1 has been operated by a user based on information from sensor film 20 regarding a position where the operation is performed, and performs processing related to control according to operated design 11a1.

When obtaining, from push-in detector 90, a detection result indicating that a user has operated operator 11, controller 140 outputs control information for vibrating vibration device 110. For example, controller 140 obtains that operator 11 is operated by a user from the detection result of push-in detector 90, and obtains a position at which the user performs the operation (which design 11a1 was operated) from information relating to the operation position from sensor film 20. Then, controller 140 outputs a control signal according to design 11a1 operated by the user to the outside. Furthermore, controller 140 may cause vibration device 110 to vibrate in a manner (e.g., frequency, vibration intensity, and the like) according to design 11a1 operated by the user. It should be noted that controller 140 may cause vibration device 110 to vibrate in a single manner (e.g., frequency, vibration intensity, and the like) regardless of which design 11a1 is operated.

Controller 140 is embodied by a processor that executes a program for controlling each component and memory that stores the program, for example. The processor reads and executes software (program) recorded in the memory, to thereby implement each function of controller 140. Furthermore, controller 140 may be embodied by a dedicated circuit. Still furthermore, controller 140 is mounted on substrate 60, for example.

### Variation 1 of Embodiment

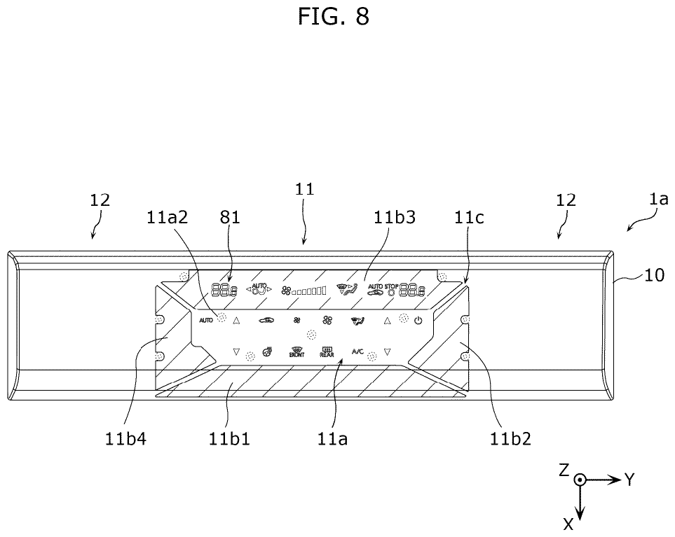

Hereinafter, an input device according to the present variation will be described with reference to FIG. 8. It should be noted that the following description will focus on a difference from the embodiment, and the description of contents that are the same or similar to the embodiment will be omitted or simplified.

FIG. 8 is a plan view showing the configuration of input device 1a according to the present variation. Although the example in which second portion 11b is provided over the entire periphery of first portion 11a in the plan view has been described in the above embodiment, second portion 11b may be provided in at least a portion of the periphery of first portion 11a. Input device 1a in which second portion 11b is provided in at least a portion of the periphery of first portion 11a in the plan view is described in the present variation.

As shown in FIG. 8, operator 11 of input device 1a includes: first portion 11a; a second portion including a plurality of second divided portions 11b1 to 11b4 provided in the periphery of first portion 11a; and third portion 11c.

Second divided portions 11b1 to 11b4 are each formed to be more flexible than first portion 11a. Second divided portions 11b to 11b4 are provided spaced apart from each other to surround first portion 11a in the plan view. The second portion includes a plurality of second divided portions 11b1 to 11b4 when viewed from the perpendicular direction.

Third portion 11c is provided in a gap in a circumferential direction of the plurality of second divided portions 11b1 to 11b4 spaced apart from each other, and is less flexible than second divided portions 11b1 to 11b4. It can also be said that third portion 11c has a higher strength than second divided portions 11b1 to 11b4. Third portion 11c is provided to separate the plurality of second divided portions 11b1 to 11b4. Third portion 11c divides the second portion into the plurality of second divided portions 11b1 to 11b4 in a circumferential direction of first portion 11a.

Third portion 11c may be thicker (longer in the X-axis direction) than, for example, second divided portions 11b1 to 11b4. For example, the thickness of third portion 11c may be greater than the thickness of second divided portions 11b1 to 11b4, and may be less than or equal to the thickness of first portion 11a. For example, the thickness of third portion 11c may be equal to the thickness of first portion 11a. Moreover, third portion 11c may include, for example, a material that is less flexible than a material of second divided portions 11b1 to 11b4. For example, third portion 11c may include, for example, a material that is less flexible than a material of second divided portions 11b1 to 11b4 and is more flexible than or as flexible as a material of first portion 11a. For example, third portion 11c may include the same material as first portion 11a.

It should be noted that the number of second divided portions is not limited to four, and may be at least one (e.g., at least two). Additionally, the second portion may include at least one of the plurality of second divided portions 11b1 to 11b4. For example, the second portion may include any of the plurality of second divided portions 11b1 to 11b4. For example, portions corresponding to second divided portions 11b2 to 11b4 in the plan view may be third portion 11c (i.e., a portion that is less flexible). The second portion may be provided in a curved portion in the periphery of first portion 11a in the plan view.

Such input device 1a is capable of decreasing the amount of push-in with respect to an operating load when first portion 11a of operator 11 is pressed, compared to a case in which the entire periphery is second portion 11b (see FIG. 2). In other words, it is possible to decrease the amount of warp of the second portion.

In input device 1a, since the second portion (e.g., second divided portions 11b1 to 11b4) that is more flexible than first portion 11a is provided in the portion of the periphery of first portion 11a, a vibration makes it easy for the user to recognize that the user has performed an operation. Accordingly, the operability of input device 1a is improved. In addition, it is possible to improve elasticity in the periphery of first portion 11a, compared to a case in which second portion 11b (see FIG. 2) is formed in the entire periphery of first portion 11a.

### Variation 2 of Embodiment

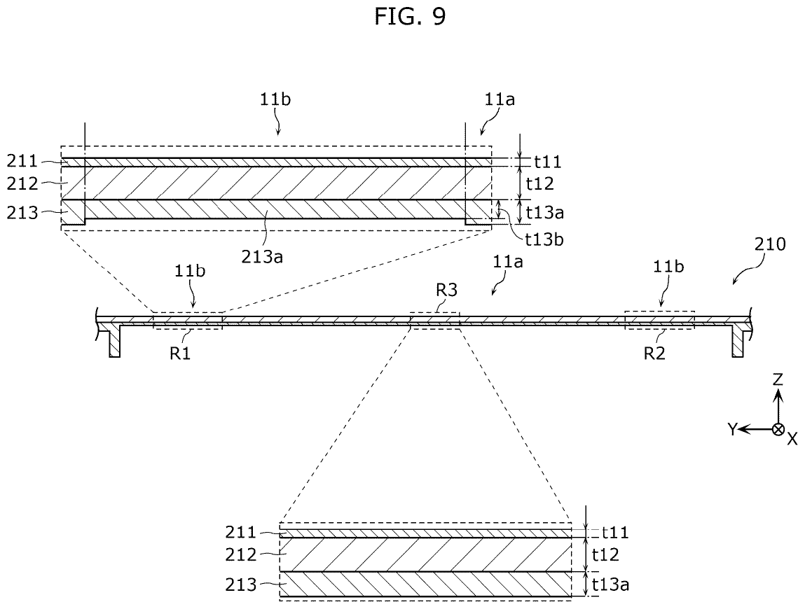

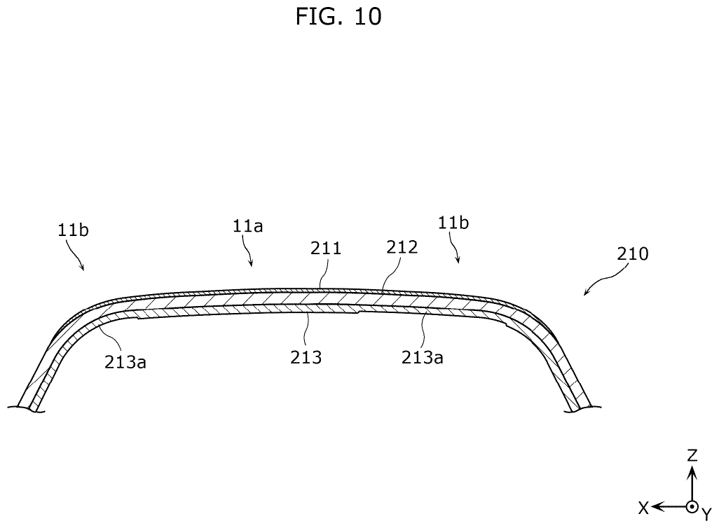

Hereinafter, an input device according to the present variation will be described with reference to FIG. 9 and FIG. 10. It should be noted that the following description will focus on a difference from the embodiment, and the description of contents that are the same or similar to the embodiment will be omitted or simplified.

FIG. 9 is a cross-sectional view showing panel 210 according to the present variation, which is taken along a cutting line corresponding to the cutting line V-V in FIG. 2. FIG. 10 is a cross-sectional view showing panel 210 according to the present variation, which is taken along a cutting line corresponding to the cutting line VI-VI in FIG. 2. Panel 210 according to the present variation differs from panel 10 according to the embodiment in including a three-layer structure. It should be noted that FIG. 9 shows enlarged cross-sectional views of dashed-line regions R1 and R3. The enlarged cross-sectional view of dashed-line region R2 may be the same as, for example, that of dashed-line region R1.

As shown in FIG. 9 and FIG. 10, panel 210 includes surface skin 211, first resin layer 212, and second resin layer 213 in stated order. Predetermined design 11a1 (see FIG. 1) may be provided on surface skin 211, may be provided on first resin layer 212, or may be provided on an other layer between surface skin 211 and first resin layer 212. Predetermined design 11a1 may be achieved by, for example, a decorative sheet.

Surface skin 211 is a portion that forms the surface of the input device according to the present variation and a user directly touches. Surface skin 211 may be light-transmissive to allow the user to visually recognize a design. Surface skin 211 is provided to cover each of first portion 11a and second portion 11b in a plan view.

Surface skin 211 includes, for example, a material that can reproduce a tactile sensation corresponding to a tactile sensation given by a portion in which the input device is provided. Surface skin 211 may include, for example, a material corresponding to the material of the portion in which the input device is provided. Surface skin 211 may include, for example, a thermoplastic resin. In the present variation, surface skin 211 includes polyvinyl chloride (PVC). It should be noted that when surface skin 211 is embedded in a portion that includes a leather-like material (e.g., genuine leather), surface skin 211 may include, for example, light-transmissive artificial leather. Additionally, surface skin 211 may include a nonwoven fabric immersed in urethane resin, or may include, for example, a thermal plastic elastomer of a urethane system.

First resin layer 212 is provided on a back surface side (the minus side of the Z axis) of surface skin 211 to give a soft tactile sensation and effectively transmit a vibration of vibration device 110 to the user when the user operates panel 210. First resin layer 212 is more flexible than second resin layer 213. First resin layer 212 may be more flexible than surface skin 211. It can also be said that first resin layer 212 is an elastic resin layer having elasticity. First resin layer 212 may include, for example, an elastomer. In addition, first resin layer 212 may include, for example, a foamable resin (e.g., a foamable urethane resin).

Second resin layer 213 is provided on a back surface side (the minus side of the Z axis) of first resin layer 212, and is less flexible than first resin layer 212. Second resin layer 213 may include, for example, a thermoplastic resin. Second resin layer 213 may include, for example, polycarbonate (PC), or may include acryl (polymethyl methacrylate (PMMC)).

Second resin layer 213 includes thin portion 213a in second portion 11b. Thickness t13b of thin portion 213a is less than thickness t13a of a portion of second resin layer 213 located in first portion 11a.

As stated above, in panel 210, a cross-sectional structure of first portion 11a and a cross-sectional structure of second portion 11b both are the three-layer structure of surface skin 211, first resin layer 212, and second resin layer 213. It can also be said that in panel 210, each of the layers is provided over first portion 11a and second portion 11b. In addition, although surface skin 211, first resin layer 212, and second resin layer 213 are stacked in contact with each other, an other layer may be provided between any of the three.

The following describes the thickness of each of the layers.

In the present variation, thickness t11 of surface skin 211 is less than any of thickness t12 of first resin layer 212 and thicknesses t13a and t13b of second resin layer 213. Thickness t11 of surface skin 211 may be, for example, at least 1.0 mm and at most 0.5 mm. Thickness of t11 of a portion of surface skin 211 located in second portion 11b may be equal to, for example, thickness t11 of a portion of surface skin 211 located in first portion 11a.

From a standpoint of making it easy to give a soft tactile sensation to the user when the user operates panel 210, and from a standpoint of making it easy for vibration device 110 to cause first portion 11a to vibrate, thickness t12 (a length in the Z-axis direction) of first resin layer 212 may be less, and is greater than any of thickness t11 and thicknesses t13a and t13b in the present variation. Thickness t12 of first resin layer 212 may be, for example, at least 1.5 mm, at least 2.0 mm, or at least 2.5 mm. In addition, the thickness of a portion of first resin layer 212 located in second portion 11b may be equal to the thickness of a portion of first resin layer 212 located in first portion 11a.

In the present variation, thicknesses t13a and t13b of second resin layer 213 are greater than thickness t11 and less than thickness t12. Thicknesses t13a and t13b of second resin layer 213 may be, for example, at least 1.0 mm or at least 1.5 mm. In addition, thickness t13b of a portion of second resin layer 213 located in second portion 11b is less than thickness t13a of a portion of second resin layer 213 located in first portion 11a.

It should be noted that thicknesses t13a and t13b may be equal to each other, the thickness of the portion of first resin layer 212 located in second portion 11b may be less than the thickness of the portion of first resin layer 212 located in first portion 11a, and the thickness of the portion of surface skin 211 located in second portion 11b may be less than the thickness of surface skin 211 located in first portion 11a.

### Other Embodiments

Although the input device etc. according to one or more aspects have been described above based on the embodiment etc., the present disclosure is not limited to the embodiment etc. Unless departing from the spirit of the present disclosure, embodiments obtained by applying various variations that are conceivable by those skilled in the art and embodiments configured by combining structural components of different embodiments may be included within the present disclosure.

For example, although the example in which the input device includes the light-transmissive panel and the light source has been described in the above-described embodiment etc., the present disclosure is not limited to the example. For example, the input device may include a panel that does not have the light transmittance property (for example, a panel that has the light blocking property) and may not include the light source. In such a case, the design displayed on the surface of the panel may be embodied by, for example, a printing layer, a sealing layer, and the like, formed by printing on a surface of the panel.

Moreover, although the example in which the plan view shape of the panel is the rectangular shape has been described in the above-described embodiment etc., the shape of the panel is not limited to such a shape and may be a circular shape or a trapezoid shape.

Furthermore, although the example in which the display is provided at the position overlapping the second portion in the plan view has been described in the above-described embodiment etc., the present disclosure is not limited to the example. At least a portion of the display may be provided at a position overlapping the first portion.

Moreover, although the example in which the input device includes the sensor film has been described in the above-described embodiment etc., the present disclosure is not limited to the example. For example, when the number of designs displayed in the first portion is one, the input device need not include the sensor film.

Furthermore, the panel according to Variation 2 of the above-described embodiment may include a surface skin, a first resin layer provided on a back surface side of the surface skin, and a second resin layer provided on a back surface side of the first resin layer, in which the first resin layer is more flexible than the second resin layer, and the second resin layer includes a first portion and a second portion that is more flexible than the first portion.

Moreover, the present disclosure may be realized as a panel (panel structure) provided in an input device. Panel 10 indicated in the embodiment and panel 210 indicated in Variation 2 of the embodiment are exemplified as such a panel.

Furthermore, the division of functional blocks in the block diagram is one example. Multiple functional blocks may be embodied as a single functional block, a single functional block may be divided into multiple functional blocks, or some functions may be moved to other functional blocks. Additionally, the functions of a plurality of functional blocks having similar functions may be processed by a single piece of hardware or software in parallel or by time-division.

Moreover, in the above-described embodiment, each constituent element (e.g., the controller) may be configured in the form of dedicated hardware or realized by executing a software program suitable for the constituent element. Each constituent element may be realized by means of a program executing unit, such as a central processing unit (CPU) or a processor, reading and executing a software program recorded on a recording medium such as a hard disk or semiconductor memory.

### Supplementary Note

The following techniques are disclosed based on the description of the above-described embodiment etc.

### (Technique 1)

An input device including: a panel that includes a surface on which a design for an operation is displayed; a holder that is provided on a back surface side of the panel and mechanically connected to the panel; a first detector that is provided on the back surface side of the panel and detects an operation on the panel from a user; and a vibration device that is mechanically connected to the holder and produces a vibration in a perpendicular direction perpendicular to the surface of the panel when the first detector detects that the panel has been operated, in which, when viewed from the perpendicular direction, the panel includes a first portion on which the design is displayed, a second portion provided in a periphery of the first portion, and a third portion, when viewed from the perpendicular direction, the second portion includes a plurality of second divided portions, the plurality of second divided portions are annularly arranged spaced apart from each other to surround the first portion, the second portion is more flexible than the first portion, and the third portion is less flexible than the second portion.

### (Technique 2)

The input device according to Technique 1, in which the second portion is thinner than the first portion.

### (Technique 3)

The input device according to Technique 1, in which the second portion includes a material that is more flexible than a material of the first portion.

### (Technique 4)

The input device according to any one of Techniques 1 to 3, in which when viewed from the perpendicular direction, the second portion includes four second divided portions.

### (Technique 5)

The input device according to any one of Techniques 1 to 4 further includes a light source that is provided on the back surface side of the panel and causes the panel to display the design.

### (Technique 6)

The input device according to any one of Techniques 1 to 5, in which a plurality of designs for operations are displayed on the first portion, and the input device further includes a second detector that detects operation positions with respect to the plurality of designs.

### (Technique 7)

The input device according to Technique 6, in which the holder and the panel are directly connected via at least two connectors, and when viewed from the perpendicular direction, the at least two connectors are provided in positions that do not overlap the plurality of designs.

### (Technique 8)

The input device according to Technique 2 or any one of Techniques 4 to 6 depending from Technique 2, in which the panel includes: a surface skin; a first resin layer that is provided on a back surface side of the surface skin; and a second resin layer that is provided on a back surface side of the first resin layer, the first resin layer is more flexible than the second resin layer, and when viewed from the perpendicular direction, the surface skin, the first resin layer, and the second resin layer are each provided over the first portion and the second portion.

### (Technique 9)

The input device according to Technique 8, in which a portion of the second resin layer that is located in the second portion is thinner than a portion of the second resin layer that is located in the first portion.

### (Technique 10)

The input device according to Technique 8 or 9, in which a portion of the first resin layer that is located in the second portion is as thick as a portion of the first resin layer that is located in the first portion.

### (Technique 11)

The input device according to any one of Techniques 8 to 10, in which the first resin layer is thicker than the second resin layer.

### (Technique 12)

A panel that is provided on a surface of an input device, in which the input device includes: a holder that is provided on a back surface side of the panel and mechanically connected to the panel; a first detector that is provided on the back surface side of the panel and detects an operation on the panel from a user; and a vibration device that is mechanically connected to the holder and produces a vibration in a perpendicular direction perpendicular to the surface of the panel when the first detector detects that the panel has been operated, when viewed from the perpendicular direction, the panel includes a first portion on which a design for an operation is displayed, a second portion provided in a periphery of the first portion, and a third portion, when viewed from the perpendicular direction, the second portion includes a plurality of second divided portions, the plurality of second divided portions are annularly arranged spaced apart from each other to surround the first portion, the third portion is provided in a gap in an annular arrangement direction of the plurality of second portions, the second portion is more flexible than the first portion, and the third portion is less flexible than the second portion.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-189671 filed on Nov. 28, 2022, Japanese Patent Application No. 2023-124859 filed on Jul. 31, 2023, and PCT International Application No. PCT/JP2023/038929 filed on Oct. 27, 2023.

### INDUSTRIAL APPLICABILITY

The present disclosure is useful for an input device mounted on a vehicle and the like.

1. An input device comprising:
a panel that includes a surface on which a design for an operation is displayed;
a holder that is provided on a back surface side of the panel and mechanically connected to the panel;
a first detector that is provided on the back surface side of the panel and detects an operation on the panel from a user; and
a vibration device that is mechanically connected to the holder and produces a vibration in a perpendicular direction perpendicular to the surface of the panel when the first detector detects that the panel has been operated,
wherein when viewed from the perpendicular direction, the panel includes a first portion on which the design is displayed, a second portion provided in a periphery of the first portion, and a third portion,
when viewed from the perpendicular direction, the second portion includes a plurality of second divided portions,
the plurality of second divided portions are annularly arranged spaced apart from each other to surround the first portion,
the third portion is provided in a gap in an annular arrangement direction of the plurality of second portions,
the second portion is more flexible than the first portion, and
the third portion is less flexible than the second portion.

2. The input device according to claim 1,
wherein the second portion is thinner than the first portion.

3. The input device according to claim 1,
wherein the second portion includes a material that is more flexible than a material of the first portion.

4. The input device according to claim 1,
wherein when viewed from the perpendicular direction, the second portion includes four second divided portions, and
the third portion is provided in each of gaps in an annular arrangement direction of the four second divided portions.

5. The input device according to claim 4,
wherein when viewed from the perpendicular direction, the third portion is provided radially from the first portion.

6. The input device according to claim 1,
wherein the panel is light-transmissive, and
the input device further comprises a light source that is provided on the back surface side of the panel and causes the panel to display the design.

7. The input device according to claim 1,
wherein a plurality of designs for operations are displayed on the first portion, and
the input device further comprises a second detector that detects operation positions with respect to the plurality of designs.

8. The input device according to claim 7,
wherein the holder and the panel are directly connected via at least two connectors, and
when viewed from the perpendicular direction, the at least two connectors are provided in positions that do not overlap the plurality of designs.

9. The input device according to claim 2,
wherein the panel includes:
a surface skin;
a first resin layer that is provided on a back surface side of the surface skin; and
a second resin layer that is provided on a back surface side of the first resin layer,
the first resin layer is more flexible than the second resin layer, and
when viewed from the perpendicular direction, the surface skin, the first resin layer, and the second resin layer are each provided over the first portion and the second portion.

10. The input device according to claim 9,
wherein a portion of the second resin layer that is located in the second portion is thinner than a portion of the second resin layer that is located in the first portion.

11. The input device according to claim 9,
wherein a portion of the first resin layer that is located in the second portion is as thick as a portion of the first resin layer that is located in the first portion.

12. The input device according to claim 9,
wherein the first resin layer is thicker than the second resin layer.

13. An input device comprising:
a panel that includes a surface on which a design for an operation is displayed;
a holder that is provided on a back surface side of the panel and mechanically connected to the panel;
a first detector that is provided on the back surface side of the panel and detects an operation on the panel from a user; and
a vibration device that is mechanically connected to the holder and produces a vibration in a perpendicular direction perpendicular to the surface of the panel when the first detector detects that the panel has been operated,
wherein when viewed from the perpendicular direction, the panel includes a first portion on which the design is displayed, and a second portion provided in a periphery of the first portion,
the second portion is more flexible than the first portion,
the second portion is thinner than the first portion, and
when viewed from a direction orthogonal to the perpendicular direction, a portion of the second portion is in a curved shape.

14. A panel that is provided on a surface of an input device,
wherein the input device includes:
a holder that is provided on a back surface side of the panel and mechanically connected to the panel;
a first detector that is provided on the back surface side of the panel and detects an operation on the panel from a user; and
a vibration device that is mechanically connected to the holder and produces a vibration in a perpendicular direction perpendicular to the surface of the panel when the first detector detects that the panel has been operated,
when viewed from the perpendicular direction, the panel includes a first portion on which a design for an operation is displayed, a second portion provided in a periphery of the first portion, and a third portion,
when viewed from the perpendicular direction, the second portion includes a plurality of second divided portions,
the plurality of second divided portions are annularly arranged spaced apart from each other to surround the first portion,
the third portion is provided in a gap in an annular arrangement direction of the plurality of second portions,
the second portion is more flexible than the first portion, and
the third portion is less flexible than the second portion.
